(19) United States
(12) Patent Application Publication
(10) Pub. No.: US 2007/0030338 A1
(43) Pub. Date: Feb. 8, 2007

(54) Video ringback tone

(75) Inventors: Yue Jun Jiang, Danville, CA (US); John Hoffman, Cornelius, NC (US)

Correspondence Address: Roamware, Inc.;Attn: Legal Department, Suite 1000, 3031 Tisch Way, San Jose, CA, 95126, US

(73) Assignee: Roamware Inc.

(21) Appl. No.: 11/197,676

(22) Filed: Aug. 4, 2005

(51) Int. Cl. H04N 7/14

(52) U.S. Cl. 348/14.01

(57) ABSTRACT

The present invention relates to methods and systems for offering calling parties a video indicia or segment while awaiting connection to a called party in a telecommunications network. CAMEL-based and switch based embodiments are described in detail, along with various cases for early and late call forwarding, completed calls and uncompleted calls.

### CROSS-REFERENCE TO RELATED APPLICATION

This application claims priority from the U.S. Provisional Patent Application Ser. No. 60/598,313, filed Aug. 2, 2004, and entitled, “VIDEO RINGBACK TONE FOR 3G OPERATORS.” This patent application constitutes the conversion of that Provisional Patent Application into a non-provisional patent application.

### BACKGROUND OF THE INVENTION

### Field of the Invention

This invention relates to methods and apparati by which a calling party using an audiovisual telecommunications device is provided with an audiovisual segment selected or designated in advance by the called party.

Currently, in the common carrier telecommunications market there is a concept called “Ringback Tones” “Tringtones” or “Color Ringback Tone,” wherein a telecommunications subscriber is able to specify in advance a short music or audio segment to be heard by callers while waiting for that subscriber to answer a call. Typically, that segment reflects a personal choice made by that subscriber for playing to all calling parties, or to calling parties specified by that subscriber with respect to that segment. Other existing concepts of Ringback Tones include ways for those segments to reflect personal choices made by the calling party. Also in existence is a service known as video mail that enables a calling party to see a video greeting and leave a video mail. However no services today include playing a video to the calling party while awaiting the called party to answer.

### SUMMARY OF THE INVENTION

The present invention relates to a service (“Video Ringback Tone”) including methods, apparati and systems enabling a calling party to be presented with a visual, motion-picture or audio-visual display while waiting for a called party or parties to answer or to receive an away message.

For purposes of illustrating Video Ringback Tone under the present invention, two innovative GSM embodiments will be explored.

The first of those GSM embodiments of Video Ringback Tone is an IN/Camel —based implementation. CAMEL Customised Application for Mobile network Enhanced Logic; an IN feature in GSM networks that enables users to carry personal services with them when roaming into other networks that support In that CAMEL-based embodiment, two additional features are taught. The first additional feature is to initiate a video call out by a Video Ringback Tone control platform as will be described. The other additional feature is to bridge two independent video call segments by means of a Video Ringback Tone control platform.

The second illustrative GSM embodiment of the Video Ringback Tone is switch-based. In this embodiement, a switch is enhanced to handle video call bridging and the Video Ringback Tone platform is a video content server. That same switch enhancement also handles substantially all call control.

### BRIEF DESCRIPTION OF THE DRAWINGS

FIG. 1 illustrates a GSM embodiment under the present invention in which call is successfully answered.

FIG. 2 illustrates a GSM embodiment under the present invention in which the call is forwarded early.

FIG. 3 illustrates a GSM embodiment under the present invention in which the call is forwarded later.

FIG. 4 illustrates a GSM embodiment under the present invention in which the call is forwarded without condition.

FIG. 5 illustrates an enhanced-switch based embodiment under the present invention, in which the call is late-call forwarded with or without condition.

### DETAILED DESCRIPTION OF THE INVENTION

This specification illustrates two specific types of embodiments for implementing Video Ringback Tone Service, using terms and constructs from GSM mobile telephony with 3G multimedia enhancements. Both approaches involve a Video Ringbacktone Control Server for administering audiovisual presentation segments in the context of calls and call attempts, and a Video Ringbacktone Content Server for hosting and transmitting those segments. The former is responsible for the video call control with respect to Video Ringback Tone and call connection. The latter is responsible for playing the personalized video for a calling party (or the “A-party”) based on the A-party and a called party (or a “B-party”) preferences.

This specification focuses on the call control rather than the video content management. The video played can, among generic or other audio-visual content segments, be B's personal video for all A-party callers or for specific A-parties or can be A's personal video for all calls or for when calling designated B-parties.

The content of the Video Ringback Tone itself is capable of many variations. Without limiting the generality of that content capability, the Video Ringback Tone is minimally comprised of any visual, audiovisual or motion picture display. That Video Ringback Tone display or motion picture segment can be comprised of any content including without limitation:
Content created by the called for display to ail called parties or to specific called parties.
Content created by third parties and selected by the called party for display to all called parties or specific called parties.
Content relating to any group with which the called party or calling party is affiliated.
Default content selected by the operator or network when the called party has not selected any.
Content that is responsive to pre-determined preferences (such as adult content controls) specified by the calling party, called party, or operator.
Advertising content selected by the operator or network, the calling party or the called party.
Content services comprising of changing, or timely content such as news, sports or entertainment information.
Locality-based content such as information relating to the calling party's or the called party's locale.
   2.1 IN/Camel based Approach

In an intelligent network (“IN”) approach with CAMEL, a party can be defined as a Video Ringback Tone subscriber or participant either as T-CSI at HLR or an HLR-vendor specific subscription class/category, (e.g. ServiceSet in Nokia™)

For the sake of scalability, in a preferred embodiment, two parameters should be present. One is the support of InitiateCallAttempt (ICA) by the IN/Camel environment. This allows the establishment of a separate call leg to locate a B-party from an A-party leg. The other is the support of MergeCallSegment (Merge/MCS) of an A-party leg and a B-party leg.

2.1.1 Successful Answer

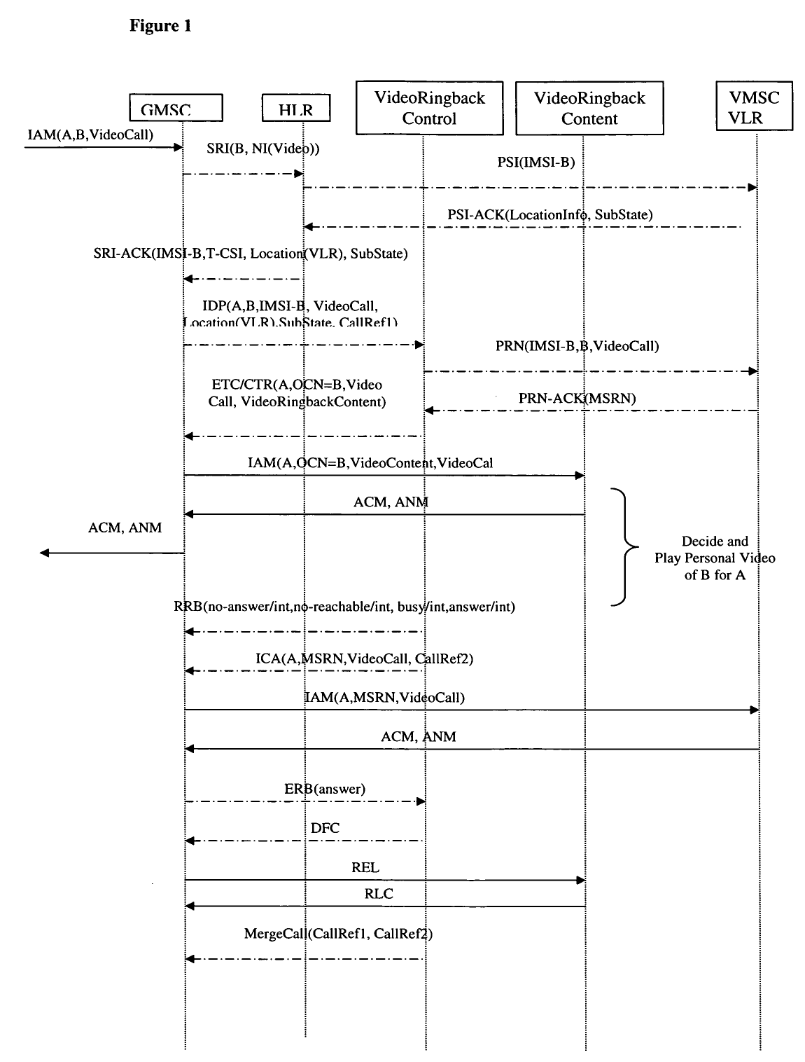

With reference to FIG. 1, when A makes a call, or a video call to B, the call reaches the GMSC of B's operator. A IAM message can indicate that this call is a video-capable call by means such as ATP and USI (“Universal Subscriber Identity” in 3G networks) parameters. That GMSC can then issue an SRI query to the HLR with Video requirements in the NSI field. The HLR can return a T_CSI or equivalent in any language or in a vendor-specific subscription trigger. The HLR might also optionally reveal or discover the location and subscriber state information from VLR if the GMSC requires it. GMSC can then issue IDP to the Video Ringback Tone Control Server with useful information including without limitation, the IMSI of B-party, video call control information, or location and subscriber state of B.

The Video Ringbacktone Control can locate the MSRN of B-party from the VLR information sent from IDP.

The Video Ringbacktone Control Server can then connect the A-party to the Video Ringbacktone Content Server which can then play B's personalized video, or any other video display or segment, to the A-party. The Video Ringback Tone Control Server can then issue ICA to GMSC to call out on B on MSRN while waiting control on B-party's reply.

When B-party answers the call, GMSC can pass the control to the Video Ringback Tone Control Server which can then disconnect the A-party call to the Video Ringback Tone Content Server and merge the A-party call with the call leg to the B-party's MSRN.

2.1.2 Unconditional Forwarding

Normally, CFU takes highest precedence in HLR, and normal unconditional forwarding would take place. The Video Ringback Tone Control Server will not need to be involved in that transaction.

2.1.3 Early Call Forwarding or Early Call Forwarding Condition

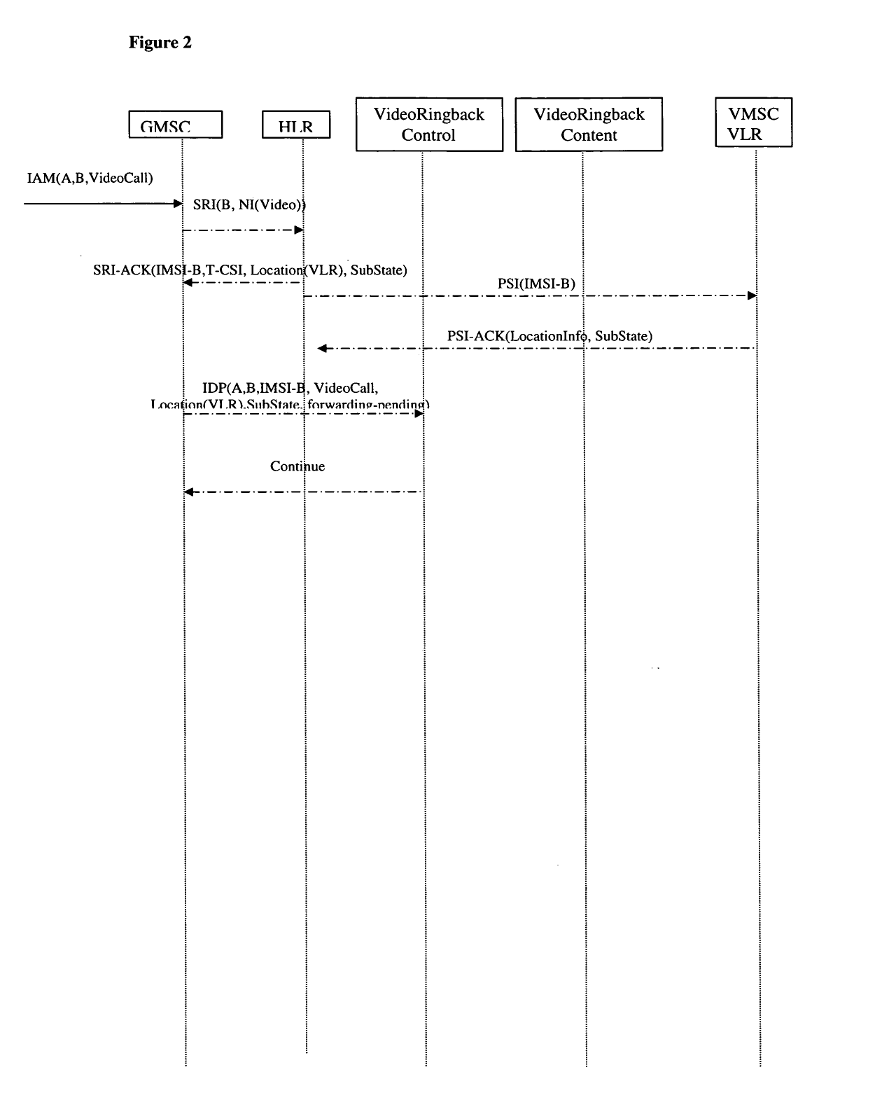

With reference to FIG. 2, when A-party makes a call, or a video call, to B-party, the call reaches GMSC of B-party's operator. The IAM message can indicate this call is a video-capable call via parameters such as ATP and USI parameters. The GMSC can then issue an SRI query to HLR with video requirements in the NSI field. HLR can then return T_CSI or equivalent in a vendor-specific subscription trigger. Alternatively or additionally, the HLR might also optionally discover or reveal the location and subscriber state information from a VLR if the GMSC requires it. The GMSC can then issue IDP to the Video Ringback Tone Control Server including any of the following: the IMSI of B-party, video call control information, location and subscriber state of B-party.

If the subscriber state indicates “IMSI-detached” then the network can be determined unreachable or busy or there is a forwarding pending value in IDP.

In that event, the Video Ringback Tone Control Server can simply indicate “Continue” to the GMSC.

2.1.4 Late Call Forwarding Condition Without Forwarding Value

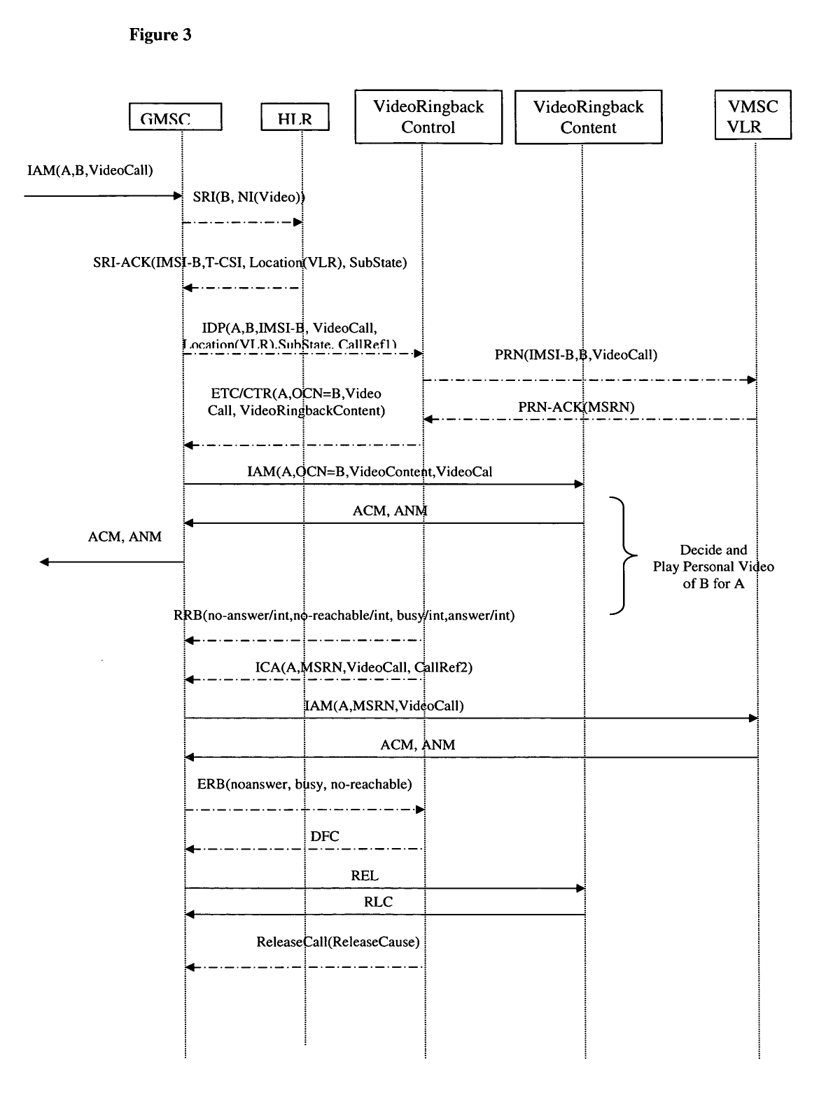

With reference to FIG. 3, when A-party makes a call, or a video call, to B-party, the call reaches GMSC of B-party's operator. The IAM message can indicate this call is a video-capable call via ATP and USI parameters. GMSC can then issue an SRI query to HLR with Video requirements in the NSI field. HLR can return T_CSI or equivalent data, optionally in a vendor-specific subscription trigger. The HLR can also optionally reveal or publish the location and subscriber state information from the VLR if a GMSC requires it. The GMSC can then indicate IDP to the Video Ringback Tone Control Server containing any of the following or other relevant information: the IMSI of B-party, video call control information, location and subscriber state of B.

The Video Ringback Tone Control Server can then locate the MSRN of B from the VLR information sent from IDP.

The Video Ringback Tone Control Server can then connect the A-party to the Video Ringback Tone Content Server which can then play B-party's personalized video or any other pre-determined audio-visual or motion picture segment to that A-party. The Vido Ringback Tone Control Server can then issue ICA to GMSC to call out on B-party on MSRN while waiting control on B's reply. When B-party, does not answer the call for any reason including without limitation because he is not reachable, busy, not answering, if there is no forwarding, VMSC can issue an instruction such as Release with Release Cause to GMSC. GMSC can map the release cause (if unknown, GMSC will need to choose a default one) to ERB and GMSC can pass the control to Video Ringback Tone Control Server which can then disconnect the A-party call to the Video Ringback Tone Content Server and ask the GMSC to release the call to the A-party with Release Cause.

GMSC can then choose to play release announcement to the A-party.

2.1.5 Late Call Forwarding Condition With Forwarding Value

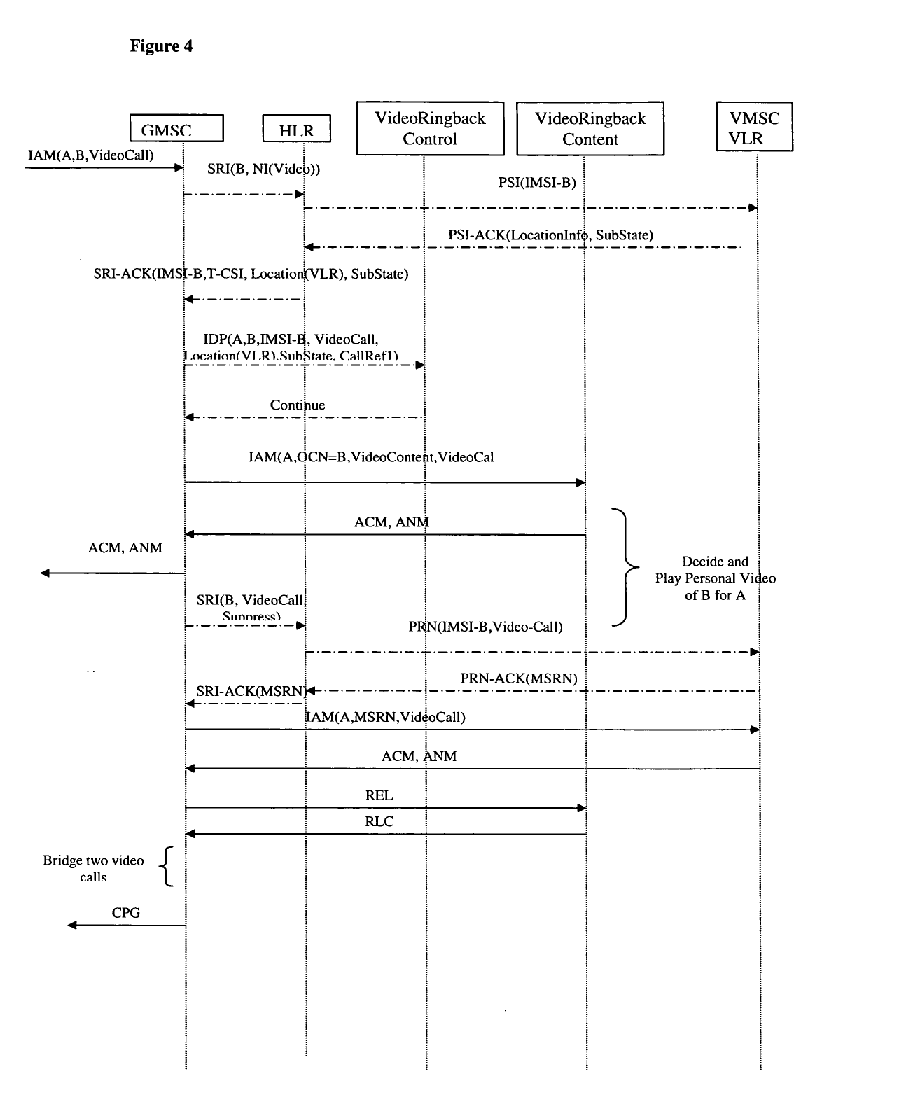

With reference to FIG. 4, when A-party makes a call, or a video-call, to B-party, the call reaches GMSC of B-party's operator. The IAM message can indicate this call is a video-capable call via any parameters or ATP or USI. GMSC can then issue an SRI query to HLR with Video requirements in the NSI field. HLR can return T_CSI or equivalent in any format or optionally in a vendor-specific subscription trigger. HLR might also optionally discover or reveal the location and subscriber state information from VLR if GMSC requires it. GMSC can then issue IDP to the Video Ringback Tone Control Server including useful information including any of the following or others: the IMSI of the B-party, video call control information, and optionally the location and subscriber state of B.

The Video Rringbacktone Control can locate the MSRN of B-party from the VLR information sent from IDP.

The Video Ringback Tone Control Server can then connect the A-party to the Video Ringback Tone Content server which will then play B's personalized video, or any other pre-designated, generic video, or a video selected based on any rules to the A-party. The Video Ringback Tone Contrl Server can then issue ICA to GMSC to call out to B-party on MSRN while waiting control on B's reply. When B does not answer the call for any reason including without limitation because she is not reachable, busy, not answering, if there is forwarding, VMSC can issue Call Progress message to GMSC after forwarding the call.

Video Ringback Tone Control server would not necessarily be made aware of this event and can handle the control transparently. That is, if later GMSC receives an Answer event, then the Video Ringback Tone Control Server can handle the call as if successful. If later GMSC receives Release event, then the Video Ringback Tone Control Server can handle the call as if late call forwarding condition occurred without forwarding value.

2.2 Switch-Based Approach

In this solution, a video ringback tone subscriber is defined by some means including without limitation as T-CSI at HLR or by means of a HLR-vendor-specific subscription class/category, (e.g. ServiceSet in Nokia) optionally in the same type of manner as in the IN/CAMEL embodiment, above.

However unlike the IN/Camel-based approach, a switch will not route call control to the Video Ringback Tone Control Server which is only needed for accounting and authentication in this switch-based approach. Instead the switch will simply route the video call directly to the Video Ringback Tone Content server.

In a preferred embodiment, the switch is modified or improved to support A-party leg and initiates a B-party leg itself. In a preferred embodiment, the switch is also modified or improved to analyze call progress message to decide whether to bridge the A-party leg and B-party leg.

When A-party makes a call, or a video call, to B-party, the call reaches GMSC of B-party's operator. The IAM message can indicate that this call is a video-capable call by any means or via ATP and USI parameters. GMSC can then issue an SRI query to HLR with Video requirements in the NSI field. HLR can return T_CSI or equivalent in any means, or in a vendor-specific subscription trigger. HLR might also optionally reveal or discover the location and subscriber state information from VLR if GMSC requires it.

GMSC may recognize the subscriber as a Video Ringback Tone subscriber from the service key in T-CSI or other service set property. It can then issue IDP to Video Ringback Tone Control Server with any of the following or other parameters: the IMSI of B-party, video call control information or location and subscriber state of B.

The Video Ringbback Tone Control issues an instruction such as, “Continue” after logging and granting the call.

If the subscriber state indicates an early call forwarding condition or there is a forwarding value, GMSC can handle the video call normally.

Otherwise, it can then issue an SRI query again on B-party with subscription trigger suppressed this time. If no MSRN is returned, normal call flow can take place.

Otherwise, GMSC will then connect the A-party to the Video Ringback Tone Content Server. It can then initiate a separate leg of call to MSRN of B-party.

When B answers the call, GMSC disconnects the A-party leg to the Video Ringbacktone Content Server and bridges the A-party leg with the MSRN-leg to the B-party.

When GMSC receives a Call Progress message that indicates unavailable, including without limitation busy, not reachable, not answering due to late call forwarding, GMSC can disconnect the A-party leg to the Video Ringback Tone Content Server and optionally bridge the A-party leg with the MSRN-leg to the B-party.

When GMSC receives a release with release cause indicating (without limitation) busy, not reachable, not answering, GMSC can disconnect the A-party leg to the Video Ringback Tone Content Server and play any release announcement according to the release cause before releasing the call to A-party.

2.2.1 Successful Answer

See FIG. 4 for an illustration of a successful answer scenario.

2.2.2 Unconditional Forwarding

Since CFU takes highest precedence in HLR, normal unconditional forwarding takes place, the Video Ringback Tone Control Server need not be involved in the transaction.

2.2.3 Early Call Forwarding or Early Call Forwarding Condition

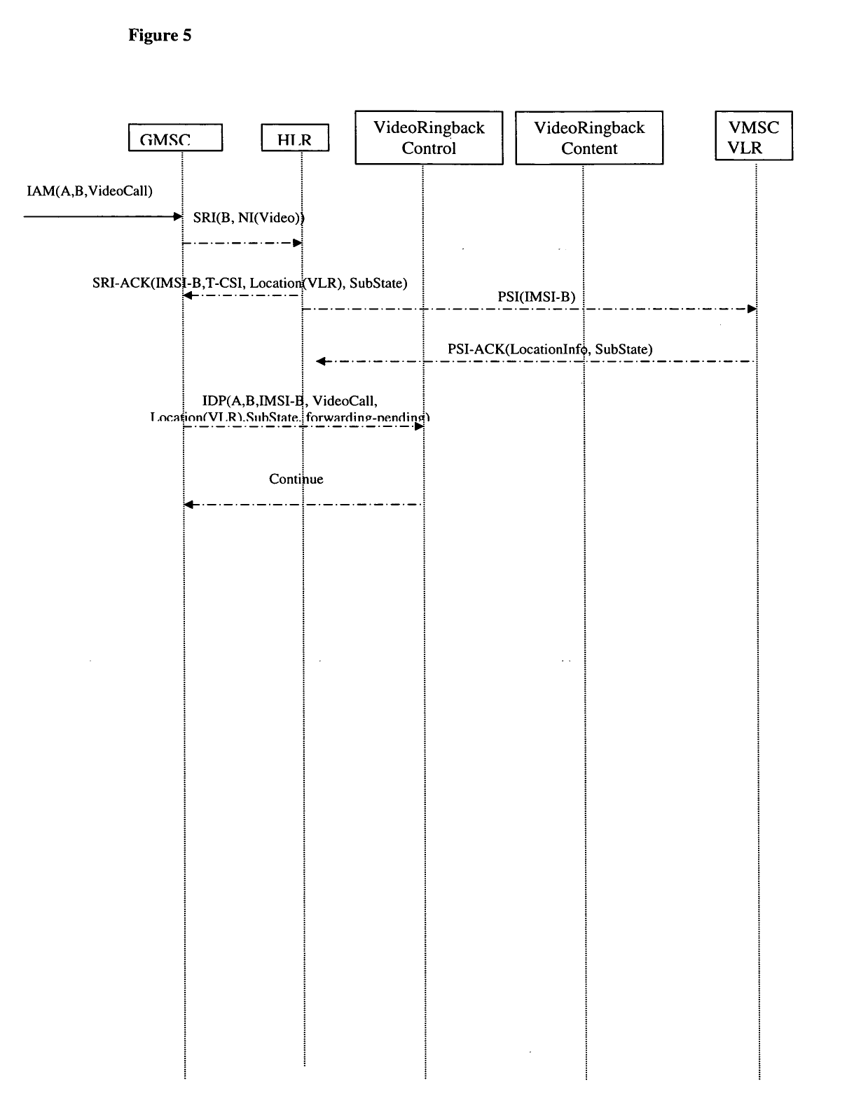

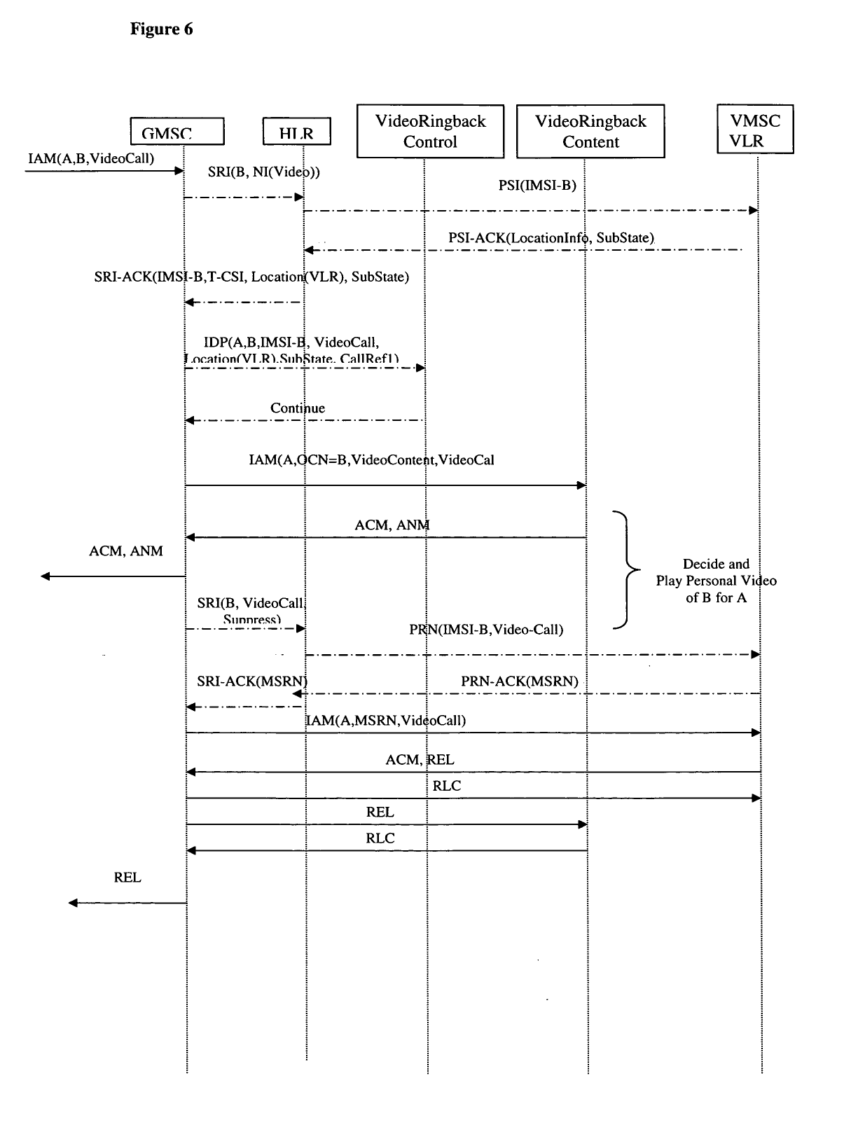

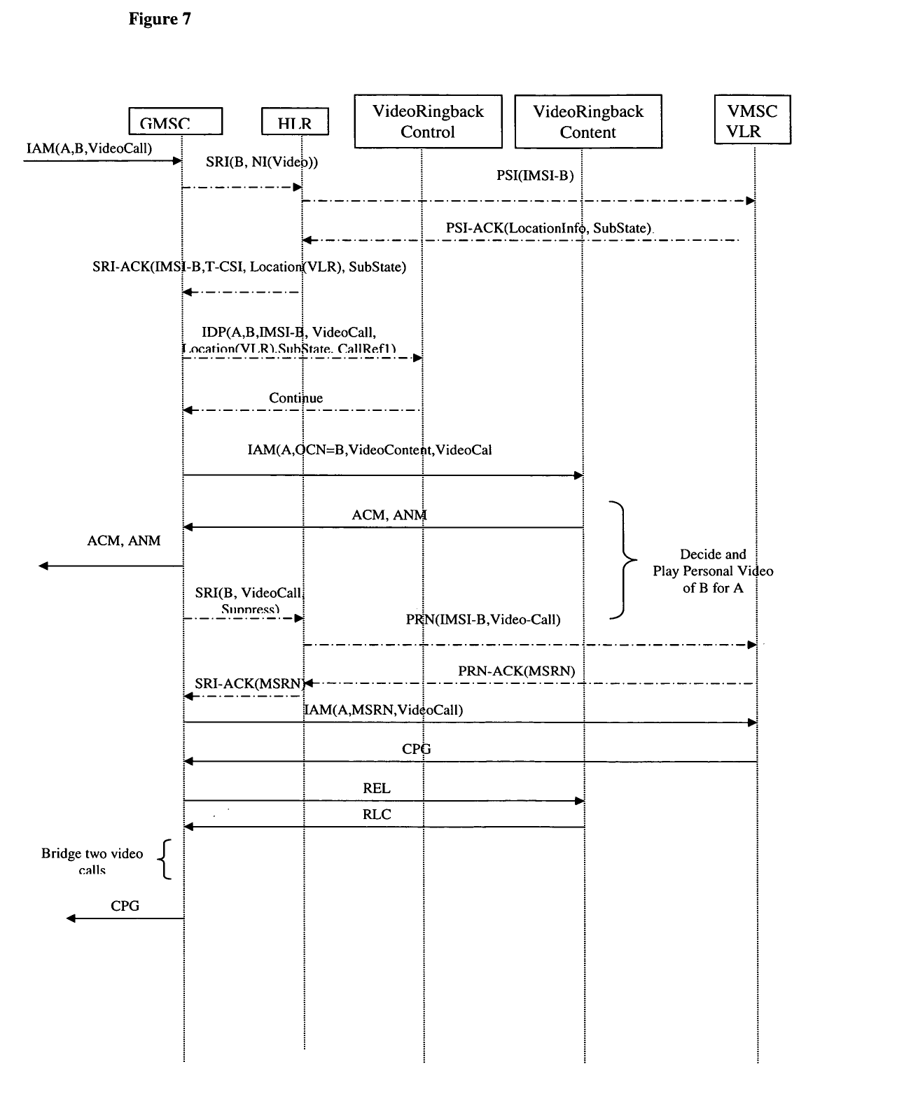

With reference to FIG. 5, when A-party makes a call, or a video call, to B-party, the call reaches the GMSC of B-party's operator. The IAM message can indicate this call is a video-capable call via parameters such as ATP and USI parameters. GMSC can then issue an SRI query to HLR with Video requirements in the NSI field. HLR can return T_CSI or equivalent in language such as a vendor-specific subscription trigger. HLR might also optionally reveal or discover the location and subscriber state information from VLR if GMSC requires it. GMSC can then issue IDP to the Video Ringback Tone Control Server with any of the following, or other useful information: B-party's IMSI, video call control information, or location and subscriber state of B-party.

If the subscriber state indicates that IMSI-detached, the network is determined unreachable or busy, or there is a forwarding pending value in IDP, then the Video Ringback Tone Control Server can issue an instruction such as “Continue” to the GMSC. GMSC can then handle the call normally.

2.2.4 Late Call Forwarding Condition Without Forwarding Value

With reference to FIG. 6, when A-party makes a call, or a video-call, the call reaches the GMSC of B-party's operator. An IAM message can indicate this call is a video-capable call via parameters such as ATP and USI parameters. The GMSC can then issue an SRI query to the HLR with Video requirements in the NSI field. The HLR can then return T_CSI or equivalent information in any format or in a vendor-specific subscription trigger. The HLR might also optionally reveal or discover the location and subscriber state information from VLR if the GMSC requires it.

The GMSC can recognize that the subscriber is a Video Ringback Tone subscriber from the service key in T-CSI or service set property. The GMSC can then issue IDP to the Video Ringback Tone Control Server with useful information such as B-party's IMSI, video call control information, or location and subscriber state of B-party.

The Video Ringback Tone Control Server can issue and instruction such as “Continue” after logging and granting the call.

If the subscriber state indicates an early call forwarding condition, or there is a forwarding value, GMSC can handle the call normally.

Otherwise, the GMSC can then issue an SRI query again on B-party with the subscription trigger suppressed this time. If no MSRN is returned, normal call flow can take place.

Otherwise, the GMSC can. then connect the A-party to the Video Ringback Tone Content Server. The GMSC can then initiate a separate leg of call to MSRN of B-party.

When B is unavailable or does not answer due to any reason including without limitation because she is busy, out of coverage or not answering the call, the VMSC can issue Release with Release Cause to the GMSC. Upon receiving Release, GMSC can disconnect the A-party leg to the Video Ringback Tone Content Server and can play any release announcement according to the release cause before releasing the call to the A-party.

2.2.5 Late Call Forwarding Condition With Forwarding Value

With reference to FIG. 7, when A makes a call, or a video call to B-party, the call reaches the GMSC of B-party's operator. The IAM message can indicate this call is a video-capable call via any parameters or ATP and USI parameters. GMSC can then issue an SRI query to the HLR with Video requirements in the NSI field. HLR can return T_CSI or equivalent in any language or in the form of a vendor-specific subscription trigger. The HLR might also optionally reveal or discover the location and subscriber state information from VLR if GMSC requires it.

The GMSC recognizes the subscriber is a Video Ringback Tone subscriber from the service key in T-CSI or service set property. The GMSC can then issue IDP to the Video Ringbacktone Control Server with useful information including without limitation the IMSI of B-party, video call control information, or location and subscriber state of B-party.

The Video Ringback Control Server can issue an instruction such as “Continue” after logging and granting the call.

If the subscriber state indicates an early call forwarding condition or there is a forwarding value, GMSC can handle the call normally.

Otherwise, the GMSC can issue an SRI query again on B-party with subscription trigger suppressed this time. If no MSRN is returned, normal call flow can take place.

Otherwise, the GMSC can then connect the A-party to the Video Ringback Tone Content Server. The GMSC can then initiate a separate leg of call to MSRN of B-party.

When GMSC receives a Call Progress message indicating that the subscriber is unavailable, including without limitation busy, not reachable, not answering due to late call forwarding, GMSC can disconnect the A-party leg to the Video Ringback Tone Content Server and bridge the A-party leg with the MSRN-leg to the B-party.

After receiving CPG message, normal call flows can follow.

Provided above for the edification of those of ordinary skill in the art, and not as a limitation on the scope of the invention are detailed illustrations of a scheme for giving calling parties video-indications of telecommunications connections in progress or under attempt. Numerous variations and modifications within the spirit of the present invention will of course occur to those of ordinary skill in the art in view of the embodiments that have now been disclosed. For example, while in the described embodiments, the present invention is implemented primarily from the point of view of common-carrier networks of voice telecommunications by mobile means, the present invention may also be effectively implemented for any facility capable of providing audio-visual telecommunications.

The examples of Video Ringback Tone detailed in the illustrative examples contained here are described using terms and constructs drawn largely from GSM and so-called “3G” mobile telephony infrastructure. But use of these examples should not be interpreted to limiting the invention to those means. Video Ringback Tone can be provided by means of any telecommunications end-user station (the “communications station”) including without limitation, (i) any mobile telephony network including without limitation GSM, PCS, TDMA, CDMA or CDMA 2000, sattelite phones or other mobile telephone networks or systems; (ii) any so-called WiFi or Wimax apparatus for receiving digital wireless communications such as a general purpose personal computer, a Palm-type, PocketPC or any other type of portable or stationary digital multimedia computer; (iii) an entertainment console platform such as Sony Playstation, Nintendo, Xbox or any similar apparatus that is capable of receiving digital multimedia communications; (iv) fixed-line devices made for receiving video communications such as the eye2eye devices from Dlink; or even (v) fixed line customer premises equipment using POTS (plain-old-telephone-service) that are enhanced to offer audiovisual communications.

In describing certain embodiments of Video Ringback Tone under the present invention, this specification follows the path of a telecommunications call from an A-party (or calling party) to a B-party (or called party.) For the avoidance of doubt, that call can be for a normal voice call, in which the subscriber telecommunications equipment is also capable of visual, audiovisual or motion-picture display. Alternatively, those calls can themselves be intended as initiating telecommunications by means of visual or motion-picture display. In further embodiments, the call can even be for text or instant messages only, but the call is announced or indicated by visual, audioi-visual or motion picture display of a Video Ringback Tone under the present invention. Namely, the type of data to be transmitted in the actual call path need not include visual, audio-visual or motion pictures in order for telecommunications to be to be preceded or announced by a Video Ringback Tone under the present invention.

Further, in describing certain embodiments of Video Ringback Tone under the presentation, point to point, or single party to single party call paths are referenced for illustration. But Video Ringback Tone under the current invention is not limited to single-point communications. The visual, audiovisual or motion picture ringback indicia under the current invention can just as easily be seen in a multi-party conference call or multi-point to multi-point broadcast scenario.

We claim:

1. A method for indicating to a calling party that a telecommunications connection to a called party is pending, the method comprising presenting the calling party with a motion picture pre-selected by the called party during the period between when the calling party requested the connection and when that connection is made.

2. An apparatus for providing a calling party with a video display relative to the called party, the apparatus comprising:
a. A telecommunications network for carrying video-capable calls;
b. A Video Ringback Tone Control Server connected with said telecommunications network, said Video Ringback Tone Control Server for directing the invocation of said video display relative to the called party in relation to calls attempted by said calling party; and
c. A Video Ringback Tone Content Server for hosting and transmitting said video display responsive to said directing.
